(19) United States
(12) Patent Application Publication
(10) Pub. No.: US 2015/0149224 A1
(43) Pub. Date: May 28, 2015

(54) ITERATIVE METHOD, SYSTEM, AND USER INTERFACE FOR ANALYSIS, PATTERN DETECTION, PREDICTIVE MODELING, AND CONTINUOUS IMPROVEMENT OF QUALITY, HEALTH, SAFETY, AND ENVIRONMENTAL (QHSE) OPERATIONS

(71) Applicant: Nathan R. Cameron, Cleveland, OH (US)

(72) Inventor: Nathan R. Cameron, Cleveland, OH (US)

(21) Appl. No.: 14/622,924

(22) Filed: Feb. 16, 2015

(51) Int. Cl. G06Q 10/06

(52) U.S. Cl. CPC G06Q 10/063
USPC 705/7.11

(57) ABSTRACT

Disclosed is an iterative method, system, and user interface for analysis, pattern detection, and predictive modeling of quality, health, safety, and environmental (QHSE) from multiple, disparate sources. This iterative method, system, and user interface makes use of user generated qualitative and quantitative data from multiple quality, health, safety, and environmental sources. Sources include; monitoring systems, witness accounts, benchmarks, and other measurement apparatuses from single or multiple geographic locations. Data is acquired, categorized, aggregated, formatted, and isolated through pre-analysis algorithms. The isolated data of significance is then analyzed through an iterative methodology of user selected algorithms. The results go through a series of post-analysis testing to determine the effectiveness of the analysis. Once the post-analysis testing is completed, it is entered into a continuous improvement matrix to determine methodologies and solutions to improve upon existing QHSE processes. These results are processed through integrated or stand-alone computer modules and output to a user interface. The user interface provides the user options for selecting, isolating, and formatting combinations of algorithms and data analysis techniques to detect underlying patterns and predictive models in current QHSE processes and to provide innovative, dynamic, and predictive continuous improvement models for improving QHSE processes.

### BACKGROUND OF THE INVENTION

This present invention is related to improving Quality, Health, Safety, and Environment (QHSE) processes and operations. There is increasing importance on the simultaneous need for the health and safety of employees, the quality of goods and services produced, and the protection, conservation, and reclamation of local communities and the natural environment. Currently a major deficiency exists for a system to fully integrate QHSE data from multiple, distinct resources and provide predictive improvement models. Companies and public entities are looking for ways to innovate and integrate QHSE processes so that they can improve margins, reduce costs, improve workplace welfare, mitigate risks, enforce regulatory compliance, and improve company profile appearances as leaders in sustainable practices. Although QHSE processes are important in all industries, they are most pronounced with those dealing with natural resource exploration, extraction, and processing. Extraction of natural resources inherently causes quality, health, safety, and environmental degradation whose costs are not internalized by the producing firm, creating externalities. Leaching, tailings, aesthetic damage, air pollution, and water pollution are all examples of this negative externality which imposes large costs on taxpayers, local communities, producing entities, and regulatory entities.

The ability to define or quantify QHSE costs and benefits is pragmatic for creating synergies between extraction industries, manufactures, suppliers, government entities, communities, and the natural environment. Different company data systems, wide-ranging statistical analysis techniques, and varying process improvement methodologies further complicate ways to address QHSE management causing unnecessary risks and delays due to the complexities in QHSE operations and processes. QHSE systems need to be robust, flexible, and fully integrated into the existing processes and operations, in order to maximize return on investment.

### BRIEF SUMMARY OF INVENTION

This invention provides an iterative system, method, and user interface for analysis, pattern detection, predictive modeling, and continuous improvement of QHSE operations.

The first embodiment of this invention is the computer based program, coding, and algorithms which are used as a standalone or integrated module for local, network, cloud, and mobile systems. These modules include; data acquisition, data aggregation, data formatting, data categorization, data isolation, Bayesian statistical and econometric analysis, Frequentist methodologies, Mixed Method approaches, posterior testing, sensitivity analysis, the continuous improvement matrix, data dashboard outputs, and data export options.

The second embodiment of this invention begins with the acquisition of user data from multiple, distinct quality, health, safety, and environmental sources. Once the data is acquired, the data is aggregated and compiled through a processing algorithm and stored in a computer, server, or cloud storage medium. This compiled data is then formatted and categorized into qualitative and quantitative areas and arranged in rows and columns easily accessible through commonly used database and spreadsheet software programs. The categorized data is then able to be isolated through the use of a series of sorting algorithms that provides statistically viable data of particular interest to the user. Once the isolated data of significant variables is confirmed by the user, it is sent from the database or spreadsheet software to the analysis.

The third embodiment of this invention is the iterative methodology of the analysis applied specifically to QHSE operations. Iterative selected tests and analyses are based upon user defined criteria to detect patterns in significant variables of the dataset. The use and analysis using Bayesian, Frequentist, and Mixed Method approaches to the content of the data provides a dynamic, flexible assessment of existing conditions and probabilistic outcomes. The significant variables then undergo a robust posterior and specification analysis to ensure proper testing procedures and analyses were selected. If posterior tests are not acceptable, the resultant data is then recycled through the iterative data analysis steps. This cyclical process continues until the data analysis based on user criteria is acceptable. The subsequent step is the performance of a sensitivity analysis on the significant variables to determine what incremental changes in these respective variables do to the overall analysis. Once the analysis is complete and confirmed by the user, it is then placed into a continuous improvement matrix.

The fourth embodiment of this invention is the user generated continuous improvement matrix. The continuous improvement matrix uses conflicting significant variables from the analysis results for row and column header inputs. Often times data results have significant variables that are in conflict with one another. For example resultant data may show conflicts between, air pollution increases v. production efficiency increases, or rate of production v. safety of employees. These conflicting variables can lead to stalemates and delays in improving QHSE operations. The variables are then analyzed with a series of Innovative Ideologies. Innovative ideologies are used to create a solution key with strategies to continuously improve upon existing QHSE operations, while specifically addressing potential conflicts.

The fifth embodiment of this invention is the user interface and export options for the created results. The user interface provides the user a written and graphical dashboard. This dashboard summarizes the previous analytical tests, posterior tests, and sensitivity analysis. It also offers the user another chance for revisions, and provides export options to the user including; print copies, mobile device storage, local computer storage, network server storage, cloud storage, and different file type exports.

### BRIEF DESCRIPTION OF THE DRAWINGS

FIG. 1 presents a schematic overview of the iterative method, system, and user interface of the present invention.

FIG. 2 presents a schematic overview of the iterative steps involved in the data acquisition, categorization, aggregation, and formatting, and isolation of multiple, distinct QHSE data sources and users.

FIG. 3 presents a schematic overview of the data analysis, posterior testing, and sensitivity analysis of significant variables and data from the isolated data in FIG. 2.

FIG. 4 presents a schematic example of the continuous improvement matrix and solution key for the user confirmed significant data results from FIG. 3.

FIG. 5 presents a schematic representation of the user interface and its display of results from the analysis, posterior tests, sensitivity analysis, and continuous improvement matrix. It also presents the user's export options available.

### DETAILED DESCRIPTION OF THE INVENTION

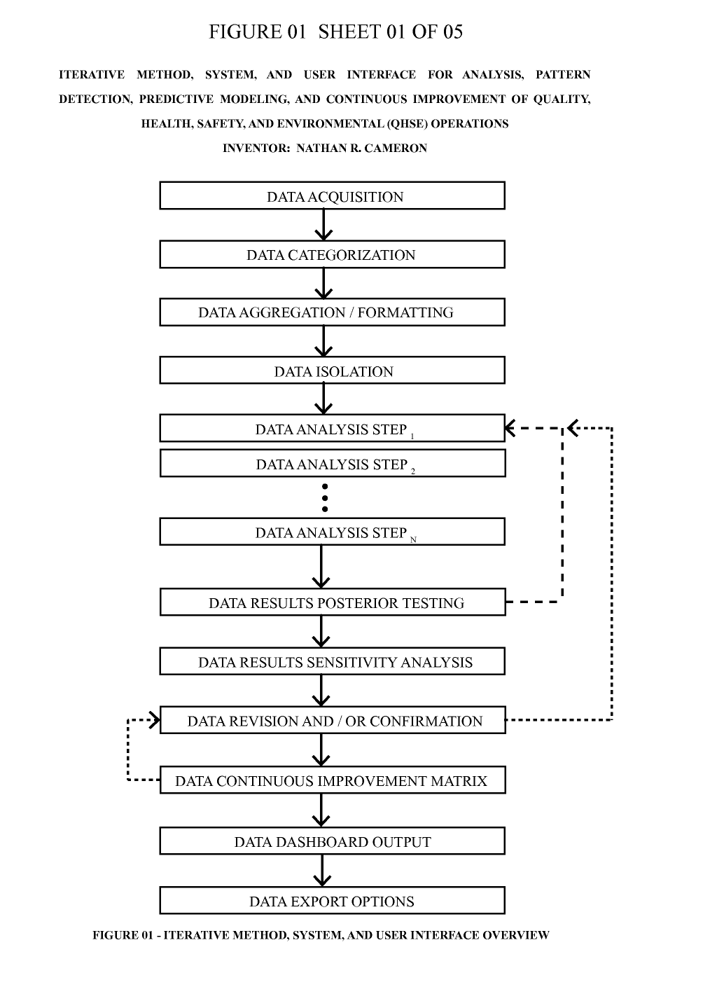

Commercial and public entities are in constant search for the sustainable growth and increasing the “triple bottom line” of economic profit, social responsibility, and environmental protection. Increasing regulations, media exposure, and global competition mean that continuous operational improvements are essential to long-term success. The often overlooked synergistic relations of Quality, Health, Safety, and Environment (QHSE) operations provide an excellent opportunity for entities to increase production, increase their public profile, reduce costs, mitigate health and safety costs, and exceed regulatory expectations. The present invention has been developed to provide an iterative method, system, and user interface for the analysis, pattern detection, predictive modeling, and continuous improvement of QHSE operations as shown in FIG. 1.

The steps and embodiments of this invention use a computer based program, coding, and algorithms which are used as a standalone or integrated module for local, network, cloud, and mobile systems. These modules include; data acquisition, data categorization, data aggregation, data formatting, data isolation, Bayesian statistical and econometric analysis, Frequentist methodologies, Mixed Method approaches, posterior testing, sensitivity analysis, the continuous improvement matrix, data dashboard outputs, and data export options.

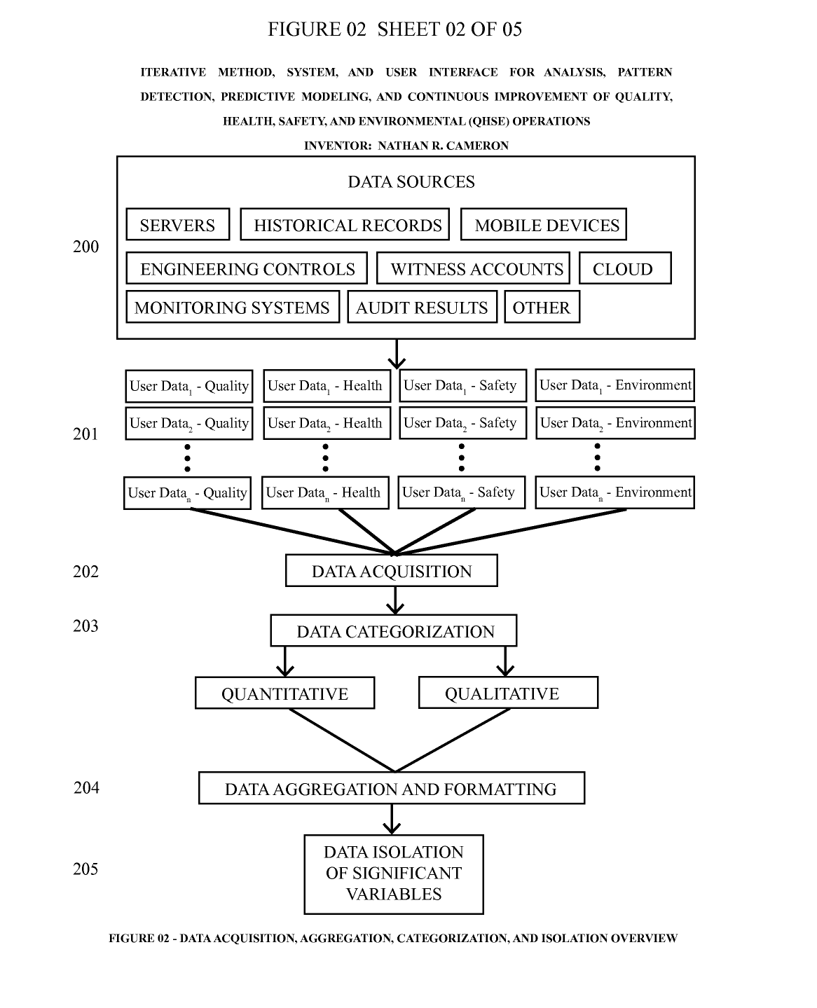

In reference to FIG. 2, data from QHSE operations can come from a myriad of different sources and locations, as shown in FIG. 2—200. This invention provides a means of acquiring data from both qualitative and quantitative sources, categorizing the data, aggregating and formatting the data, and isolating data of interest to the user. Data sources can be from different internal sources and departments including, but not limited to; manufacturing lines, field service crews, monitoring devices, QHSE Audits, human resources, accounting, marketing, sales, and high-level management. Data sources can also come from external sources including, but not limited to; competitive benchmarking, geophysical sources, ecological sources, macro-economic data, government research projects, eye witnesses, laws, and regulations (FIG. 2—200). The data can be acquired from multiple users of cross-disciplinary backgrounds (FIG. 2—201). After the data is acquired (FIG. 2—202), it is categorized as qualitative or quantitative data types based on the initial source properties and metadata (FIG. 2—203). The categorized data then goes through a variety of pre-analysis aggregation and formatting tests (FIG. 2—204). These user selected tests include, but are not limited to; normalization, parsing, clustering, dependency, and dimensionality algorithms. This aggregated and formatted data is convertible to be easily read in row and column formats. The row and column formatted data is easily readable and accessible with standard or customized spreadsheet and database software. The methods of data pre-screening are selected by the user based upon their dataset, preferences, and the needed potential improvement solutions. Once aggregated and formatted the sets of data can be isolated by the user for variables of interest (FIG. 2—205). The isolated data can be sorted and filtered through algorithms in its stand-alone mode or from the user's database and spreadsheet software.

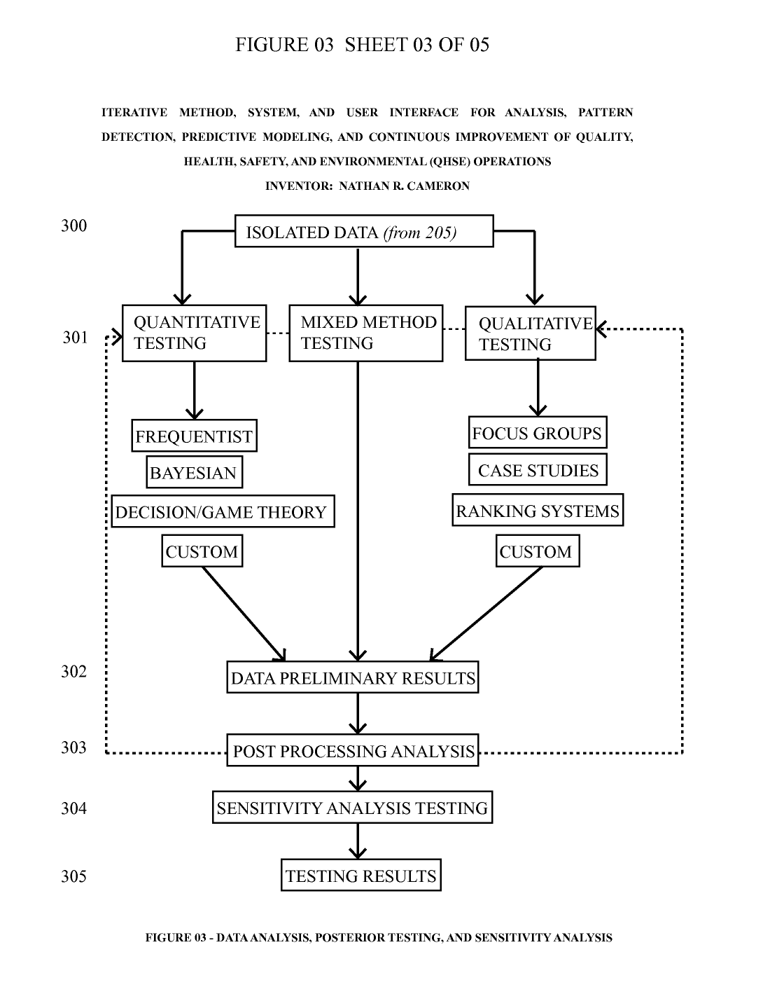

The isolated data from FIG. 2—205 is input and transferred into the data analysis module (FIG. 3—300). This data analysis module allows the user to first specify the type of methodologies to be run based upon quantitative or qualitative data (FIG. 3—301). Once a data type analysis is made, the user is provided iterative test selections through the computer module.

The quantitative testing selection includes, but is not limited to;
Frequentist methodologies are based on traditional hypothesis testing, frequencies and proportional data, averages, confidence intervals, R² values, and distribution test statistics. Frequentist statistics estimate unknown parameters of variable relationships and tests their statistical significance. This testing methodology includes sampling, simplifying assumptions, experimental design, parameter estimations, and various regression analyses. This type of testing is often used for repeatable experiments that can be designed controlled for a null hypothesis. This type of methodology is suited to factory, manufacturing, and lab settings where high levels of control are present.
Bayesian methodologies are based on historical prior data distribution, likelihood functions, and posterior distribution. Bayesian testing methodologies are beneficial to dynamic optimization outcomes and handling datasets with large amounts of inherent uncertainties. These uncertainties are commonly found throughout QHSE datasets where variability can be location based, weather related, and disturbance related. Complex ecological-social-economical phenomenon are able to be iteratively and adaptively managed through Bayesian methodologies
Decision/Game Theory methodologies are used when analysis of strategic decision making is of interest. This methodology looks at the participating entities, possible choices, sequences of events, and uncertainties. Data and actions of one entity influence and change subsequent data from other sources. The methodology takes into account conflicting and cooperative interactions between entities and analyzes optimal solutions based on criteria of interest. The evaluation of strategies is essential as companies look to continuously improve upon QHSE processes with large amounts of existing data, external competition, and regulatory uncertainty.
Custom/Other methodologies give the user the ability to add, design, and integrate proprietary modeling techniques.
   Given the vast amount of data, uncertainty, and dynamic scenarios influencing QHSE operations, this invention provides a large increase in utility to decision makers looking for flexible and robust models to improve upon their existing QHSE operations.

The qualitative selection includes a variety of methods and techniques including, but not limited to; focus groups, ranking systems, content analysis studies, and custom solutions. A great deal of insight can be obtained by customer accounts, witness accounts, market surveys, interviews, and additional qualitative information. This invention uses proprietary codes and algorithms to discern insights into these sources, which allows subsequent analysis to take place.
Focus Groups provide dynamic feedback and specific details on how process and operational improvements are having effect on the overall QHSE of an entity. Employees of geographically and socially diverse backgrounds are able to provide insight into what their perceptions, feelings, and opinions are about a project. This data is then used in a series of user selected analysis tests to continually improve upon QHSE processes.
Case Studies are important in QHSE operations. The methodologies used for case studies help provide insight in evaluating existing programs, benchmarking competitive processes, and develop recommendations for future actions. Multiple facets of an issue are able to be discovered to provide further insight.
Ranking Systems vary in methodologies from simple numerical or ordinal rankings to complex algorithms. Ranking Systems are essential in analyzing qualitative data for continuous improvement of QHSE operations. The ranking systems are selected by the user and include. but are not limited to; Friedman Testing, AHP variations, Kruskall Wallis Testing, Rank Sum, Spearman, Bootstrapping variations, and Wilcoxon.
Custom/Other methodologies give the user the ability to add, design, and integrate proprietary modeling techniques.

Mixed Method testing and analysis merges the data from the qualitative and quantitative categories. Mixed method can provide an equal and unequal merge as to what type of data is given priority over another. This type of testing and analysis allows the user to view significant variables from different perspectives. It is especially useful when combining the quantitative nature of manufacturing and ecological phenomena with social data. Multiple solutions could be possible based on cultural paradigms and thought processes. This invention allows the user to take this into account, meaning that geographically different users could shows differences in resultant data.

The preliminary resultant data (FIG. 3—302) then undergoes post-process analysis. Posterior testing (FIG. 3—303) algorithms examine how well the tests fit and analyze the data. These post-processing tests provide validation and confirmation to the preliminary resultant data.

The validated data then undergoes sensitivity analysis (FIG. 3—304) to provide the user insight into how incremental changes in significant variables affect the outcome of QHSE operational improvements.

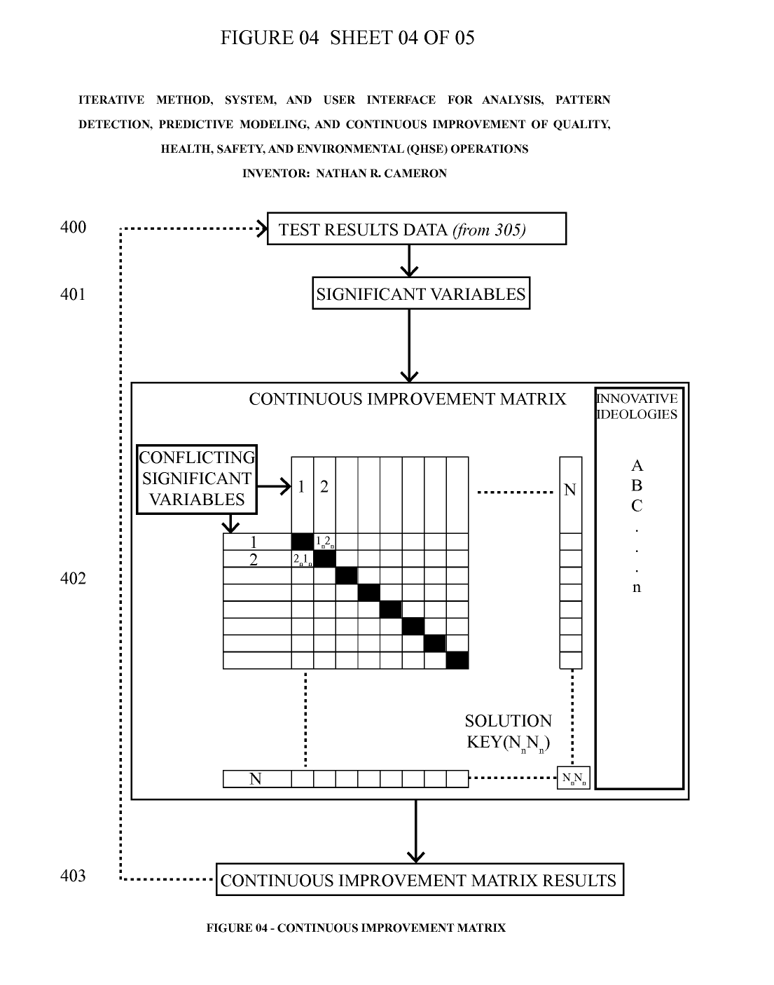

The test resultant data (FIG. 4—400) then can be entered into a continuous improvement matrix. The significant conflicting variables are extruded from the data (FIG. 4—401) and placed into the column and row headers of the continuous improvement matrix. The conflicting variables are then compared using a series of Innovative Ideologies to create a solution key for QHSE process improvements (FIG. 4—402). The solution key provides continuous improvement matrix results, which demonstrate how to mitigate conflicting data and expedite improvements through Innovative Ideologies in QHSE operations (FIG. 4—403).

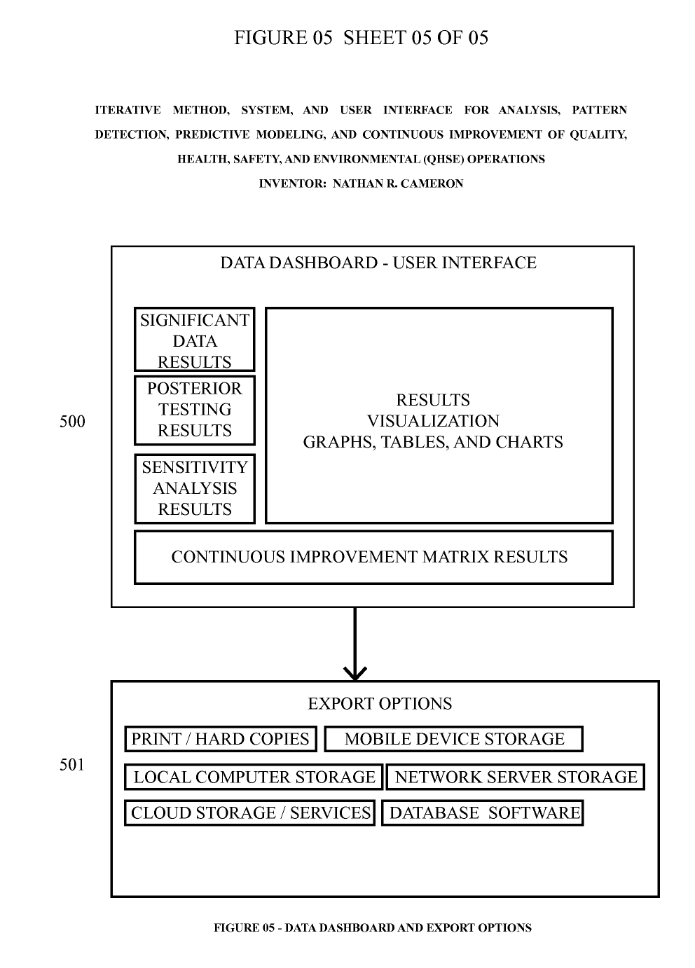

FIG. 5—500 depicts the sample layout of the user interface. The user interface provides the user a written and graphical dashboard summary of the analysis tests, posterior testing results, sensitivity analysis, and continuous improvement matrix results. This interface can be a stand-alone computer module or be integrated into standard widely used business intelligence systems, databases, and spreadsheet programs. The user is able to select the results of interest for further revisions and export options. The module provides numerous export options (FIG. 5—501) to the user including; print copies, mobile device storage, local computer storage, network server storage, cloud storage. File exports are either from the stand-alone computer module or the choices used in the integrated program of the user.

This invention has been described in terms of preferred embodiments and illustrations; however someone who is skilled in this art may apply variations to the system, method, and user interface without leaving behind the essence, concept, and scope of this invention. All similar substitutes, variations, and modifications are deemed to be within the scope of this invention. This invention has a diverse set of applications, and the present examples do not limit the scope of this invention.

### REFERENCES

US PATENT DOCUMENTS

| | | |
|---|---|---|
| 8,560,359 B2 | October 2013 | Salle et al. |
| 2012/0265324 A1 | October 2012 | Colombo et al. |
| 8,595,169 B1 | November 2013 | Adams et al. |
| 8,185,422 B2 | May 2012 | Yurekli et al. |
| 8,744,891 B1 | June 2014 | Medina III. |
| 2008/0262872 A1 | October 2008 | Perry et al. |
| 2008/0227066 A1 | September 2008 | Beygelzimer et al. |
| 2013/0275167 A1 | October 2013 | Queiroz. |
| 2012/0284039 A1 | November 2012 | Kass-Hout et al. |
| 8,825,395 B2 | September 2014 | Boss et al. |
| 8,954,375 B2 | February 2015 | Kehoe et al |
| 8,781,869 B2 | July 2014 | Cantor et al |
| 8,660,884 B2 | February 2014 | Chen-Ritzo et al |
| 8,620,729 B2 | December 2013 | Srinivasa et al |
| 8,577,718 B2 | November 2013 | Wolf et al |
| 8,676,721 B2 | March 2014 | Piovesan et al |
| 8,504,364 B2 | August 2013 | Nebot |
| 7,155,507 B2 | December 2006 | Hirano et al |
| 5,808,916 | September 1998 | Orr et al |
| 2014/0298286 A1 | October 2014 | Howard |
| 2014/0130007 A1 | May 2014 | Lewis |
| 2012/0331443 A1 | December 2012 | Amid et al |
| 2012/0297359 A1 | November 2012 | Chen et al |
| 2012/0066662 A1 | March 2012 | Chao |

### Non-Patent Literature

Ahlroth, S., Nilsson, M., Finnveden, G., Hjelm, O., & Hochschorner, E. (2011). Weighting and valuation in selected environmental systems analysis tools—suggestions for further developments. Journal of Cleaner Production, 19(2-3), 145-156.
Ammenberg, J., & Sundin, E. (2005). Products in environmental management systems: drivers, barriers and experiences. Journal of Cleaner Production, 13(4), 405-415.
Badri, A., Gbodossou, A., & Nadeau, S. (2012). Occupational health and safety risks: Towards the integration into project management. Safety Science, 50(2), 190-198.
Bernardo, M. (2014). Integration of management systems as an innovation: a proposal for a new model. Journal of Cleaner Production, 82(0), 132-142.
Bernardo, M., Casadesus, M., Karapetrovic, S., & Heras, I. (2009). How integrated are environmental, quality and other standardized management systems? An empirical study. Journal of Cleaner Production, 17(8), 742-750.
Cagno, E., Micheli, G. J. L., Masi, D., & Jacinto, C. (2013). Economic evaluation of OSH and its way to SMEs: A constructive review. Safety Science, 53(0), 134-152.
Carlson, R., Erixon, M., Forsberg, P., & Pålsson, A. C. (2001). System for integrated business environmental information management. Advances in Environmental Research, 5(4), 369-375.
Carlson, R., & Pålsson, A.-C. (2001). Industrial environmental information management for technical systems. Journal of Cleaner Production, 9(5), 429-435.
Carruthers, G., & Vanclay, F. (2012). The intrinsic features of Environmental Management Systems that facilitate adoption and encourage innovation in primary industries. Journal of Environmental Management, 110(0), 125-134.
Castelletti, A., Galelli, S., Restelli, M., & Soncini-Sessa, R. (2012). Data-driven dynamic emulation modelling for the optimal management of environmental systems. Environmental Modelling & Software, 34(0), 30-43.
Celik, M. (2009). A hybrid design methodology for structuring an Integrated Environmental Management System (IEMS) for shipping business. Journal of Environmental Management, 90(3), 1469-1475.
Chen, H., Chang, Y.-C., & Chen, K.-C. (2014). Integrated wetland management: An analysis with group model building based on system dynamics model. Journal of Environmental Management, 146(0), 309-319.
Chin, S., Kim, K., & Kim, Y.-S. (2004). A process-based quality management information system. Automation in Construction, 13(2), 241-259.
Colledani, M., Tolio, T., Fischer, A., Iung, B., Lanza, G., Schmitt, R., & Váncza, J. (2014). Design and management of manufacturing systems for production quality. CIRP Annals—Manufacturing Technology, 63(2), 773-796.
Derossi, C. R. F., & Bruno, J. C. S. (2004). Building an effective QHSE system. Paper presented at the SPE International Conference on Health, Safety and Environment in Oil and Gas Exploration and Production, Mar. 29, 2004-Mar. 31, 2004, Calgary, Alta., Canada.
Dicks, L. V., Walsh, J. C., & Sutherland, W. J. (2014). Organising evidence for environmental management decisions: a ‘4S’ hierarchy. Trends in Ecology & Evolution, 29(11), 607-613.
Dodsworth, M., Connelly, K. E., Ellett, C. J., & Sharratt, P. (2007). Organizational Climate Metrics as Safety, Health and Environment Performance Indicators and an Aid to Relative Risk Ranking within Industry. Process Safety and Environmental Protection, 85(1), 59-69.
Donnelly, K., Beckett-Furnell, Z., Traeger, S., Okrasinski, T., & Holman, S. (2006). Eco-design implemented through a product-based environmental management system. Journal of Cleaner Production, 14(15-16), 1357-1367.
Ferenhof, H. A., Vignochi, L., Selig, P. M., Lezana, Á. G. R., & Campos, L. M. S. (2014). Environmental management systems in small and medium-sized enterprises: an analysis and systematic review. Journal of Cleaner Production, 74(0), 44-53.
Fok, L. Y., Fok, W. M., & Hartman, S. J. (2001). Exploring the relationship between total quality management and information systems development. Information & Management, 38(6), 355-371.
Frysinger, S. P. (2001). An integrated environmental information system (IEIS) for corporate environmental management. Advances in Environmental Research, 5(4), 361-367.
Gernuks, M., Buchgeister, J., & Schebek, L. (2007). Assessment of environmental aspects and determination of environmental targets within environmental management systems (EMS)—development of a procedure for Volkswagen. Journal of Cleaner Production, 15(11-12), 1063-1075.
Gibson, D. W. (2004). Enhanced environmental management for land based seismic acquisition using a quality, health, safety and environmental management system. Paper presented at the SPE International Conference on Health, Safety and Environment in Oil and Gas Exploration and Production, Mar. 29, 2004-Mar. 31, 2004, Calgary, Alta., Canada.
González-Benito, J., Lannelongue, G., & Queiruga, D. (2011). Stakeholders and environmental management systems: a synergistic influence on environmental imbalance. Journal of Cleaner Production, 19(14), 1622-1630.
Gotschol, A., De Giovanni, P., & Esposito Vinzi, V. (2014). Is environmental management an economically sustainable business? Journal of Environmental Management, 144(0), 73-82.
Guerrero-Baena, M. D., Gómez-Limón, J. A., & Fruet, J. V. A multicriteria method for environmental management system selection: an intellectual capital approach. Journal of Cleaner Production (0).
Guo, Z. (1998). Preliminary analysis on setting up QHSE management system. Paper presented at the Proceedings of the 1998 International Symposium on Safety Science and Technology, ISSST, Sep. 1, 1998-Sep. 1, 1998, Beijing, China.
Hillary, R. (2004). Environmental management systems and the smaller enterprise. Journal of Cleaner Production, 12(6), 561-569.
Houlbrook, A., & Lyon, A. (2006). An approach to QHSE management in an emerging technology. Paper presented at the 8th SPE International Conference on Health, Safety and Environment in Oil and Gas Exploration and Production 2006, Apr. 2, 2006-Apr. 4, 2006, Abu Dhabi, United arab emirates.
Hui, I. K., Chan, A. H. S., & Pun, K. F. (2001). A study of the Environmental Management System implementation practices. Journal of Cleaner Production, 9(3), 269-276.
Ilangkumaran, M., Karthikeyan, M., Ramachandran, T., Boopathiraja, M., & Kirubakaran, B. (2015). Risk analysis and warning rate of hot environment for foundry industry using hybrid MCDM technique. Safety Science, 72(0), 133-143.
Iyer, S. N. (2006). Integrated management system—Implementing QHSE into projects from beginning to end. Paper presented at the 12th Abu Dhabi International Petroleum Exhibition and Conference, ADIPEC 2006: Meeting the Increasing Oil and Gas Demand Through Innovation, Nov. 5, 2006-Nov. 8, 2006, Abu Dhabi, United arab emirates.
Jalali Naini, S. G., Aliahmadi, A. R., & Jafari-Eskandari, M. (2011). Designing a mixed performance measurement system for environmental supply chain management using evolutionary game theory and balanced scorecard: A case study of an auto industry supply chain. Resources, Conservation and Recycling, 55(6), 593-603.
Jankal, R. (2014). Software Support of Quality Management in the Service Sector. Procedia—Social and Behavioral Sciences, 149(0), 443-448.
Josimović, B., Marić, I., & Milijić, S. (2015). Multi-criteria evaluation in strategic environmental assessment for waste management plan, a case study: The city of Belgrade. Waste Management, 36(0), 331-342.
Kao, J.-J., Pan, T.-C., & Lin, C.-M. (2009). An environmental sustainability based budget allocation system for regional water quality management. Journal of Environmental Management, 90(2), 699-709.
Karapetrovic, S., & Casadesus, M. (2009). Implementing environmental with other standardized management systems: Scope, sequence, time and integration. Journal of Cleaner Production, 17(5), 533-540.
Khalili, N. R., & Duecker, S. (2013). Application of multi-criteria decision analysis in design of sustainable environmental management system framework. Journal of Cleaner Production, 47(0), 188-198.
Lau, H. C. W., Ho, G. T. S., Chu, K. F., Ho, W., & Lee, C. K. M. (2009). Development of an intelligent quality management system using fuzzy association rules. Expert Systems with Applications, 36(2, Part 1), 1801-1815.
Legg, S. J., Olsen, K. B., Laird, I. S., & Hasle, P. (2015). Managing safety in small and medium enterprises. Safety Science, 71, Part C(0), 189-196.
Li, Y. F., Li, Y. P., Huang, G. H., Zhou, M., & Xie, Y. L. (2010). Modeling for Environmental-Economic Management Systems under Uncertainty. Procedia Environmental Sciences, 2(0), 192-198.
Love, P. E. D., & Irani, Z. (2003). A project management quality cost information system for the construction industry. Information & Management, 40(7), 649-661.
Lozano, M., & Vallés, J. (2007). An analysis of the implementation of an environmental management system in a local public administration. Journal of Environmental Management, 82(4), 495-511.
Ma, S., Zhang, S., Chen, Y., & Zheng, H. (2013). Design and Realization of a Major Environmental Risk Source Management System. Procedia Environmental Sciences, 18(0), 372-376.
Mahmoud, H. B., Ketata, R., Romdhane, T. B., & Ahmed, S. B. (2011). A multiobjective-optimization approach for a piloted quality-management system: A comparison of two approaches for a case study. Computers in Industry, 62(4), 460-466.
Makin, A. M., & Winder, C. (2008). A new conceptual framework to improve the application of occupational health and safety management systems. Safety Science, 46(6), 935-948.
Massei, G., Rocchi, L., Paolotti, L., Greco, S., & Boggia, A. (2014). Decision Support Systems for environmental management: A case study on wastewater from agriculture. Journal of Environmental Management, 146(0), 491-504.
Nawrocka, D., & Parker, T. (2009). Finding the connection: environmental management systems and environmental performance. Journal of Cleaner Production, 17(6), 601-607.
Pérez-Aróstegui, M. N., Bustinza-Sánchez, F., & Barrales-Molina, V. Exploring the relationship between information technology competence and quality management. BRQ Business Research Quarterly(0).
Pinto, A. (2014). QRAM a Qualitative Occupational Safety Risk Assessment Model for the construction industry that incorporate uncertainties by the use of fuzzy sets. Safety Science, 63(0), 57-76.
Pinto, A., Nunes, I. L., & Ribeiro, R. A. (2011). Occupational risk assessment in construction industry—Overview and reflection. Safety Science, 49(5), 616-624.
Pizzol, M., Scotti, M., & Thomsen, M. (2013). Network Analysis as a tool for assessing environmental sustainability: Applying the ecosystem perspective to a Danish Water Management System. Journal of Environmental Management, 118(0), 21-31.
Podgórski, D. (2015). Measuring operational performance of OSH management system—A demonstration of AHP-based selection of leading key performance indicators. Safety Science, 73(0), 146-166.
Pyon, C. U., Lee, M. J., & Park, S. C. (2009). Decision support system for service quality management using customer knowledge in public service organization. Expert Systems with Applications, 36(4), 8227-8238.
Qing, L., Rengkui, L., Jun, Z., & Quanxin, S. (2014). Quality Risk Management Model for Railway Construction Projects. Procedia Engineering, 84(0), 195-203.
Qinqin, C., Jia, Q., Yuan, Z., & Huang, L. (2014). Environmental risk source management system for the petrochemical industry. Process Safety and Environmental Protection, 92(3), 251-260.
Ramli, A. A., Watada, J., & Pedrycz, W. (2011). Possibilistic regression analysis of influential factors for occupational health and safety management systems. Safety Science, 49(8-9), 1110-1117.
Rezaei, A. R., [symbol] elik, T., & Baalousha, Y. (2011). Performance measurement in a quality management system. Scientia Iranica, 18(3), 742-752.
Rieckhof, R., Bergmann, A., & Guenther, E. Interrelating material flow cost accounting with management control systems to introduce resource efficiency into strategy. Journal of Cleaner Production (0).
Roy, M. M., Hunter, B., & Leuterman, A. J. J. (2010). Innovative system promotes cost effective identification of regulatory requirements for a global oilfield service company. Paper presented at the SPE International Conference on Health, Safety and Environment in Oil and Gas Exploration and Production 2010, Apr. 12, 2010-Apr. 14, 2010, Rio de Janeiro, Brazil.
Santos, G., Barros, S., Mendes, F., & Lopes, N. (2013). The main benefits associated with health and safety management systems certification in Portuguese small and medium enterprises post quality management system certification. Safety Science, 51(1), 29-36.
Simon, A., Bernardo, M., Karapetrovic, S., & Casadesús, M. (2011). Integration of standardized environmental and quality management systems audits. Journal of Cleaner Production, 19(17-18), 2057-2065.
Tappura, S., Sievänen, M., Heikkilä, J., Jussila, A., & Nenonen, N. (2015). A management accounting perspective on safety. Safety Science, 71, Part B(0), 151-159.
Theodosiou, G., Stylos, N., & Koroneos, C. Integration of the environmental management aspect in the optimization of the design and planning of energy systems. Journal of Cleaner Production (0).
Titu, A. M., & Vlad, A. I. (2014). Quality Indicators in Reference to the Evaluation of the Quality Management of Services in Local Public Administration. Procedia Economics and Finance, 16(0), 131-140.
Tung, A., Baird, K., & Schoch, H. (2014). The relationship between organisational factors and the effectiveness of environmental management. Journal of Environmental Management, 144(0), 186-196.
van Harten, W. H., Casparie, T. F., & Fisscher, 0. A. M. (2000). Methodological considerations on the assessment of the implementation of quality management systems. Health Policy, 54(3), 187-200.
Veltri, A., Pagell, M., Johnston, D., Tompa, E., Robson, L., Amick Iii, B. C., . . . . Macdonald, S. (2013). Understanding safety in the context of business operations: An exploratory study using case studies. Safety Science, 55(0), 119-134.
Wardhani, V., Utarini, A., van Dijk, J. P., Post, D., & Groothoff, J. W. (2009). Determinants of quality management systems implementation in hospitals. Health Policy, 89(3), 239-251.
Werner, A. K., Vink, S., Watt, K., & Jagals, P. (2015). Environmental health impacts of unconventional natural gas development: A review of the current strength of evidence. Science of The Total Environment, 505(0), 1127-1141.
Wiig, S., Robert, G., Anderson, J. E., Pietikainen, E., Reiman, T., Macchi, L., & Aase, K. (2014). Applying different quality and safety models in healthcare improvement work: Boundary objects and system thinking. Reliability Engineering & System Safety, 125(0), 134-144.
Wu, Y., & Zhang, B.-Y. (2013). The application of enterprise QHSE management performance evaluation system based on maturity model. Paper presented at the 19th International Conference on Industrial Engineering and Engineering Management: Engineering Management, Oct. 27, 2012-Oct. 29, 2012, Changsha, China.
Yaqiong, L., Man, L. K., & Zhang, W. (2011). Fuzzy theory applied in quality management of distributed manufacturing system: A literature review and classification. Engineering Applications of Artificial Intelligence, 24(2), 266-277.
Yeung, C. L., & Chan, L. Y. (1998). Quality Management System development: Some implications from case studies. Computers & Industrial Engineering, 35(1-2), 221-224.
Zaretzky, A. N. (2008). Quality management systems from the perspective of organization of complex systems. Mathematical and Computer Modelling, 48(7-8), 1170-1177.
Zhang, X., Huang, G. H., Nie, X., & Lin, Q. (2011). Model-based decision support system for water quality management under hybrid uncertainty. Expert Systems with Applications, 38(3), 2809-2816.
Zhang, Z., Song, T., & Song, J. (2014). Analysis of Relationship between Quality Management System and Design Assurance System. Procedia Engineering, 80(0), 565-572.
Zhao, Y., Sharma, A., Sivakumar, B., Marshall, L., Wang, P., & Jiang, J. (2014). A Bayesian method for multi-pollution source water quality model and seasonal water quality management in river segments. Environmental Modelling & Software, 57(0), 216-226.
Zheng, G., Zhu, N., Tian, Z., Chen, Y., & Sun, B. (2012). Application of a trapezoidal fuzzy AHP method for work safety evaluation and early warning rating of hot and humid environments. Safety Science, 50(2), 228-239.
Zhi-qiang, W., & Wei-ming, G. (2011). The Study of Management Information System for Coal Mine Safety Quality Standardization. Procedia Engineering, 26(0), 1970-1976.
Zhou, Z., Goh, Y. M., & Li, Q. (2015). Overview and analysis of safety management studies in the construction industry. Safety Science, 72(0), 337-350.
Zhu, Q., Cordeiro, J., & Sarkis, J. (2013). Institutional pressures, dynamic capabilities and environmental management systems: Investigating the ISO 9000—Environmental management system implementation linkage. Journal of Environmental Management, 114(0), 232-242.
Zorpas, A. (2010). Environmental management systems as sustainable tools in the way of life for the SMEs and VSMEs. Bioresource Technology, 101(6), 1544-1557.

1. An iterative method, system, and user interface for analysis, pattern detection, predictive modeling, and continuous process improvement of quality, health, safety, and environment (QHSE) operations based on the following steps:
a. quantitative and qualitative user data acquisition, categorization, aggregation, formatting, and isolation from multiple, disparate QHSE sources;
b. data analysis through user selected qualitative, quantitative, and mixed method analysis methodologies, iterative levels of analysis, posterior testing, and compatibility testing;
c. review and revision through sensitivity testing on initial data and test selections;
d. resultant data used in a continuous improvement matrix for conflicting variables of interest;
e. a user interface output showing analysis results, patterns and trends, predictive models, and continuous process improvement results;
f. export of resources to print copies, local storage devices, network storage devices, and cloud storage devices;

2. Method of claim 1 wherein the user uses computer based standalone or integrated modules with necessary programming, coding, and algorithms to perform analyses.

3. Method of claim 2 wherein user data is acquired from multiple quantitative and qualitative sources in the same or varied geographic locations.

4. Method of claim 3 wherein data is categorized into quantitative and qualitative types.

5. Method of claim 4 wherein the categorized data is aggregated through pre-analysis algorithms including, but not limited to; clustering, normalization, transformation, extraction, scaling, calibration and formatted into rows and columns.

6. Method of claim 5 wherein the formatted data is isolated based on the users preference of significance for their projects.

7. Method of claim 6 wherein iterative analysis of data is analyzed through qualitative, quantitative, and Mixed Method processes.

8. Method of claim 7 wherein quantitative analysis of data is done through Bayesian, Frequentist, Decision/Game Theory, and Customized methodologies.

9. Method of claim 7 wherein qualitative analysis of data is done through Focus Groups, Case Studies, Ranking Systems, and Customized methodologies

10. Method of claim 7 wherein Mixed methodologies are conducted.

11. Method of claim 7 wherein iterations of testing and analysis are used to detect patterns of data, which are significant to the user.

12. Method of claim 11 wherein subsequent analysis of resultant data goes through posterior, specification, and compatibility algorithms to determine appropriateness of previously selected tests.

13. Method of claim 12 wherein resultant data undergoes sensitivity analysis to determine the effect of incremental changes in data significant to the user.

14. Method of claim 13 wherein the resultant data is finalized or revised by the user by confirming the results or running another series of analyses.

15. Method of claim 14 wherein the finalized data is input into a continuous improvement matrix featuring innovative ideologies, which are applied to conflicting variables creating a solution key to provide ways of improving upon existing QHSE operations.

16. Method of claim 1 wherein results of analysis are provided through a user interface which shows significant patterns detected, predictive model results, and continuous improvement solutions.

17. Method of claim 16 wherein the final analysis results, patterns, models, and improvement matrices are exported and stored into print, local computer storage, mobile devices, network storage, or cloud storage systems for subsequent viewing and testing.
